(19) United States
(12) Patent Application Publication
(10) Pub. No.: US 2010/0239798 A1
(43) Pub. Date: Sep. 23, 2010

(54) ELECTROMAGNETIC COMPATIBLE CONTAINERS

(75) Inventor: Dennis M. Becklin, Grants Pass, OR (US)

Correspondence Address: BLACK LOWE & GRAHAM, PLLC, 701 FIFTH AVENUE, SUITE 4800, SEATTLE, WA, 98104, US

(73) Assignee: Environmental Container Systems, d/b/a ECS Composites, Grants Pass, OR (US)

(21) Appl. No.: 12/405,876

(22) Filed: Mar. 17, 2009

(51) Int. Cl. B32B 1/02; B29C 70/06; B29C 37/00

(52) U.S. Cl. 428/35.7; 264/258; 264/138

(57) ABSTRACT

An electromagnetic compatible container is molded from a carbon fiber reinforced polymeric material to provide a sufficient amount of structural durability while substantially preventing equipment within the container from electromagnetic interference. In one embodiment, the container is produced from a carbon fiber reinforced polypropylene sheet material that is selectively cut to form portions of the container that define a cavity for housing the equipment. The carbon fibers may be substantially encased within the polymeric material. Further, the container may have a low surface energy combined with a high level of electrical conductivity.

### FIELD OF THE INVENTION

This invention relates to a container that is electromagnetically compatible, and more specifically relates to a container stacking system having universal members that engage the different stacking patterns.

### BACKGROUND OF THE INVENTION

Various types of containers, which may take the form of transit containers, rack-mount containers, tote containers or other types of containers, are often utilized to receive, house and support delicate or sensitive cargo, such as, but not limited to electronic, computer, optical and other types of equipment. These containers are often used in military and commercial environments and may be used in environments where electronic communication is essential. By way of example, equipment within such an environment may be subjected to unwanted electromagnetic interference, which in turn may affect the efficiency, effectiveness and overall operation of the equipment.

Electromagnetic interference (EMI), also referred to as radio frequency interference (RFI), is an unwanted disturbance that affects an electrical circuit due to either electromagnetic conduction or electromagnetic radiation emitted from an external source. The disturbance may interrupt, obstruct, or otherwise degrade or limit the effective performance of the circuit. EMI can be employed intentionally in some forms of electronic warfare or can occur unintentionally. Radiated EMI may be broadly categorized as either narrowband or broadband.

Narrowband interference usually arises from intentional transmissions such as from radio and TV stations, pager transmitters, cellular phones, etc. Broadband interference usually comes from incidental radio frequency emitters, which may include electric power transmission lines, electric motors, thermostats, bug zappers, etc. Anywhere electrical power is being turned off and on is a potential source.

EMI is typically received through a process called inductive coupling, which occurs where the source and receiver are separated by a short distance (typically less than a wavelength). Inductive coupling may include electrical induction (generally referred to as capacitive coupling) and magnetic induction (generally referred to as inductive coupling). Capacitive coupling occurs when a varying electrical field exists between two adjacent conductors typically less than a wavelength apart, inducing a change in voltage across the gap. Inductive coupling occurs when a varying magnetic field exists between two parallel conductors typically less than a wavelength apart, inducing a change in voltage along the receiving conductor.

### SUMMARY OF THE INVENTION

Containers, such as transit containers, rack-mount containers, tote containers or other types of containers are molded from a carbon fiber reinforced polymeric material to provide a sufficient amount of structural durability while substantially preventing equipment within the container from electromagnetic interference. In one embodiment, the container is produced from a carbon fiber reinforced polypropylene sheet material that is selectively cut to form a container shell with a cavity for housing the equipment. The carbon fibers may be completely encased within the polymeric material. Further, the container may have a low surface energy combined with a high level of electrical conductivity.

In one example of the invention, a container includes a first container portion molded from a carbon fiber reinforced polymeric material. The container further includes a second container portion attachable to and cooperating with the first container portion to define a cavity, the second container portion molded from the carbon fiber reinforced polymeric material. In addition, the carbon fiber reinforced polymeric material is configured to substantially shield items housed within the cavity from a desired amount of electromagnetic interference.

In another example of the invention, a method of making a container includes the steps of (1) arranging carbon fibers in a desired pattern; (2) encasing the arranged carbon fibers in a polymeric material to produce a carbon fiber reinforced polymeric sheet material; (3) molding a first piece of the sheet material to form a first portion of the container; and (4) molding a second piece of the sheet material to form a second portion of the container. In one embodiment, molding the sheet materials to form the first and second portions includes arranging the sheet materials to form a cavity. The first and second portions operate to substantially shield equipment within the cavity from a desired amount of electromagnetic interference.

### BRIEF DESCRIPTION OF THE DRAWINGS

The preferred and alternative embodiments of the present invention are described in detail below with reference to the following drawings.

FIG. 1 shows a perspective view of an electromagnetic compatible container made from a carbon fiber reinforced polymeric material according to an embodiment of the present invention; and

FIG. 2 shows a method of making an electromagnetic compatible container according to an embodiment of the present invention.

### DETAILED DESCRIPTION OF THE PREFERRED EMBODIMENT

Described herein as an example of the present invention, an electromagnetic compatible container is molded from a carbon fiber reinforced polymeric material to provide a sufficient amount of structural durability while substantially preventing equipment within the container from electromagnetic interference. In one embodiment, the container is produced from a carbon fiber reinforced polypropylene sheet material that is selectively cut to form a container shell with a cavity for housing the equipment. The carbon fibers may be completely encased within the polymeric material. Further, the container may have a low surface energy combined with a high level of electrical conductivity.

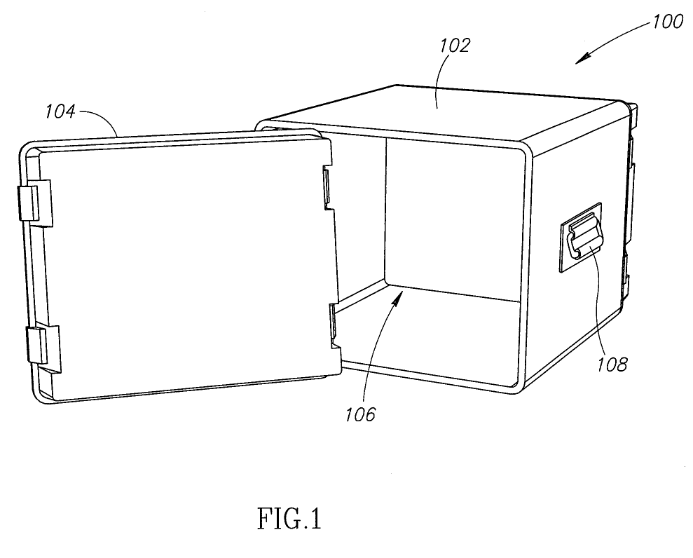

FIG. 1 shows a container 100 having a centerbody 102 and at least one lid or cover 104 attachable to the centerbody 102 to define a cavity 106. Handles 108 may be coupled to the centerbody 102 for lifting or maneuvering the container 100. In the illustrated embodiment, the centerbody 102 and the lid 104 are molded from a carbon fiber reinforced polymeric material to provide a sufficient amount of structural durability while substantially preventing equipment within the cavity 106 from electromagnetic interference. By way of example, the container 100 may be produced from a carbon fiber reinforced polypropylene sheet material selectively cut to form the centerbody 102 and the lid 104. The carbon fibers may be completely encased within the polypropylene sheet material, which in turn provides the container 100 with a low surface energy while the carbon fibers operate provide a high level of electrical conductivity.

For a general comparison purposes, water has a surface tension of about seventy (70) dynes per centimeter (dynes/cm). As illustrated in the table below, the surface energy of water is greater than most polymeric or plastic materials.

| MATERIAL | DYNES/CM |
|---|---|
| Polyhexafluoropropylene | 16 |
| Polytetrafluoroethylene (PTFE/Teflon) | 18-20 |
| Fluorinated ethylene propylene (FEP) | 18-22 |
| Chlorotrifluoroethylene (Aclar) | 20-24 |
| Polydimethyl siloxane (silicone elastomer) | 22-24 |
| Natural rubber | 24 |
| Polyvinylidene fluoride (PVDF) | 25 |
| Polyvinyl fluoride (PVF/Tedlar) | 28 |
| Polypropylene (PP) | 29-31 |
| Polyethylene (PE) | 30-31 |
| Polychlorotrifluoroethylene (PCTFE) | 31 |
| Polybutylene teraphthalate (PBT) | 32 |
| Nylon-11 (polyundecanamide) | 33 |
| Polystyrene (PS), low ionomer | 33-35 |
| Polyacrylate (acrylic film) | 35 |
| Polyvinyl chloride (PVC), plasticized | 33-38 |
| Polyvinyl chloride (PVC), rigid | 39 |
| Polyimide | 40 |
| Polysulfone (PSU) | 41 |
| Nylon-6 (polycaprolactam) | 42 |
| Polyethylene terephthalate (PET) | 41-44 |
| Cellulose (regenerated) | 44 |
| Copper | 44 |
| Aluminum | 45 |
| Iron | 46 |
| Styrene butadiene rubber | 48 |

As noted above, the carbon fibers may be completely encased within the polypropylene sheet material or other plastic material. Such encasement advantageously prevents exposure of the carbon fibers to an ambient environment and thus prevents or significantly reduces hydroscopic-related changes to the fibers after the container 100 is in service. The arrangement of the carbon fibers within the polymeric material may be customized to provide the container 100 with a desired amount of structural durability or load carrying capacity in certain directions or in certain regions of the container 100. In one embodiment, the carbon fibers are arranged into a knitted pattern before being encased in the polymeric material. In another embodiment, the carbon fibers are arranged into a woven pattern. In addition, the low surface energy of the container 100 is sufficient to shield the cavity 106 within the container 100 from various types of electromagnetic interference.

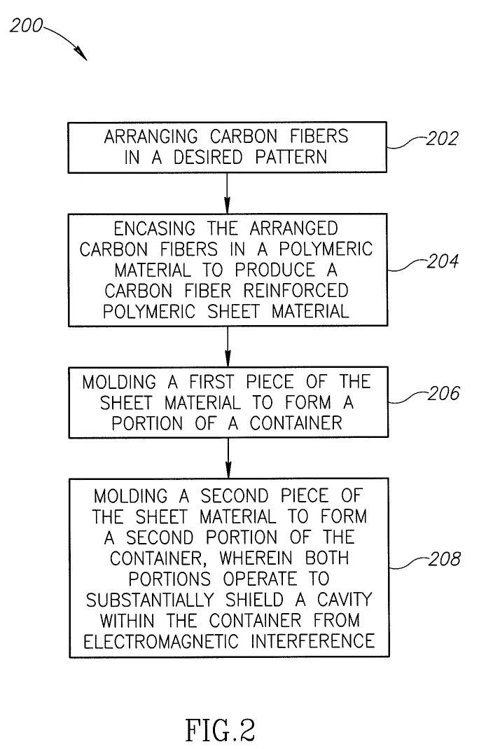

FIG. 2 shows a method 200 for making the container 100. At step 202, the carbon fibers are arranged in a desired pattern, such as, but not limited to a knitted or woven pattern. At step 204, the carbon fibers are then encased in a polymeric material to produce a carbon fiber reinforced polymeric sheet material. At step 206, a first piece of the sheet material is molded to form a first portion of the container, which may be either the centerbody or the lid or the container. And at step 208, a second piece of the sheet material is molded to form a second portion of the container that cooperates with the first portion to define the cavity 106. In one embodiment, molding the sheet materials to form the first and second portions includes arranging the sheet materials about the cavity to substantially shield equipment or other items within the cavity from a desired level of electromagnetic interference.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A container comprising:
a first container portion molded from a carbon fiber reinforced polymeric material; and
a second container portion attachable to and cooperating with the first container portion to define a cavity, the second container portion molded from the carbon fiber reinforced polymeric material,
wherein the carbon fiber reinforced polymeric material is configured to substantially shield items housed within the cavity from electromagnetic interference.

2. The container of claim 1, wherein the carbon fibers are arranged into a knitted pattern.

3. The container of claim 1, wherein the polymeric material is thermoplastic material.

4. The container of claim 3, wherein the thermoplastic material is polypropylene.

5. The container of claim 1, wherein the carbon fiber reinforced polymeric material includes a desired surface energy below seventy dynes per centimeter.

6. The container of claim 1, wherein carbon fibers are substantially encased in the polymeric material to prevent exposure of the carbon fibers to an ambient environment.

7. The container of claim 1, wherein carbon fibers are completely encased in the polymeric material to prevent exposure of the carbon fibers to an ambient environment.

8. The container of claim 1, wherein the container is a reusable container.

9. The container of claim 1, wherein the carbon fiber reinforced polymeric material is in the form of a carbon fiber reinforced polymeric sheet material.

10. A method of making a container, the method comprising:
arranging carbon fibers in a desired pattern;
encasing the arranged carbon fibers in a polymeric material to produce a carbon fiber reinforced polymeric sheet material;
molding a first piece of the sheet material to form a first portion of the container; and
molding a second piece of the sheet material to form a second portion of the container,
wherein molding the sheet materials to form the first and second portions includes arranging the sheet materials to form a cavity and wherein the first and second portions operate to substantially shield equipment within the cavity from electromagnetic interference.

11. The method of claim 10, wherein encasing the arranged carbon fibers includes substantially encasing the carbon fibers in the polymeric material to prevent exposure of the carbon fibers to an ambient environment.

12. The method of claim 10, wherein encasing the arranged carbon fibers includes completely encasing the carbon fibers in the polymeric material to prevent exposure of the carbon fibers to an ambient environment.

13. The method of claim 10, wherein molding the first portion of the container includes molding a lid of the container.

14. The method of claim 10, wherein molding the second portion of the container includes molding a main body of the container.

15. The method of claim 10, further comprising cutting the sheet material to form the first piece.

16. The method of claim 10, further comprising cutting the sheet material to form the second piece.

17. The method of claim 10, wherein molding the first and second portions includes configuring a structurally durable container.
